(19) United States
(12) Patent Application Publication
(10) Pub. No.: US 2004/0059675 A1
(43) Pub. Date: Mar. 25, 2004

(54) System and method for replacing identification data on a portable transaction device

(76) Inventor: Joel Gaillard, Nassau (BS)

Correspondence Address: Donald Fraser, MACMILLAN, SOBANSKI & TODD, 132C West Second Street, Perrysburg, OH, 43551-1401, US

(21) Appl. No.: 10/652,363

(22) Filed: Aug. 29, 2003

Related U.S. Application Data
(63) Continuation of application No. PCT/IB01/00940, filed on May 28, 2001.
(60) Provisional application No. 60/276,119, filed on Mar. 16, 2001.

(51) Int. Cl. G06F 17/60; H04K 1/00; H04L 9/00

(52) U.S. Cl. 705/42; 705/64

(57) ABSTRACT

The method of renewal of first identification data identifying and being associated with an account hosted in a financial institution, the first identification data being stored on a portable transaction device and at the financial institution, comprises the steps of:

i) the first identification data is communicated to the financial institution;

j) second identification data is generated which is stored at the financial institution and on the portable transaction device, in place of the first identification data; and

k) second identification data is associated to the account of the financial institution for the purpose of ulterior identification of the account by means of the second identification data.

### FIELD OF THE INVENTION

The present invention relates to portable transaction devices, and more particularly to a system and method for the renewal of identification data on a portable transaction device.

### BACKGROUND OF THE INVENTION

Portable transaction devices (PTD) such as smart cards, credit cards, debit cards, electronic wallets or other similar devices, are well known and commonly used. In the example of a credit card PTD, this card has identification data related thereto in the form of a card number which includes a certain number of digits. An expiration date is also usually associated to a credit card. Other data can also be included on the card, for example the name of the cardholder. However, the credit card number represents the identification data of the card, given that the card number represents the data which is used for the purpose of identification of the cardholder's account at the financial institution that issued the card, for example the credit company in the case of a credit card. This identification data is hence used to apply to the account associated with the credit card monetary transactions made by means of the credit card.

Usually, the card number is printed or stamped directly onto the material of the card, for example by means of a press which will deform the card made of plastic in order for the card number to be presented in relief on the card surface. Thus, the card number identification data cannot be modified in any way other than by replacing the card by a new card provided with a new number. In the present specification, such identification data which cannot be modified on the card will be identified by the expression “permanent identification data”.

A problem associated to such permanent identification data is that this principle allows the usage by others of the permanent identification data for fraudulent purposes. Indeed, in today's society, a credit card can for example be used on the phone, by verbally transmitting to a product or service provider the credit card's number and expiration date. Person to person product or service sales can also occur during which the permanent identification data will be indicated to the product or service provider. Sales through a computer linked to a network such as Internet can also be performed, during which the identification data will be transmitted through this computer network. In every case, the credit card itself is not necessarily required, and the sale of the product or the service can occur if the permanent identification data is known and if the account associated with the card is valid. If a third party becomes aware of the permanent identification data of the credit card of another person, then this third party could accomplish a transaction on the basis of this knowledge, the debit related with the transaction then being applied to cardholder's account without his authorization. A third party can become aware of the permanent identification data of a card during any usage of this card: for example, if this data is transmitted by telephone, then the attendant of the service provider can keep the permanent identification data of the card for ulterior fraudulent usage; if this data is transmitted by Internet, a computer hack could enable a third party to intercept the data transmission for ulterior fraudulent usage; or else if this data is transmitted in a conventional fashion through the instrumentality of an interface machine located at the business place of a product or service provider, it often happens that the permanent identification data of the card appears on the copy of the receipt which is kept by the product or service provider, and a person having access to these receipts could then keep the permanent identification data of the card for ulterior fraudulent usage purposes.

As regards an electronic wallet, this PTD is loaded with a certain amount of money by means of a suitable interface machine, and this amount of money is afterwards considered as being carried by the electronic wallet itself. When a transaction has to be accomplished by means of the electronic wallet, the amount of money associated with the transaction is transferred, by means of another suitable interface machine, from the electronic wallet to a recipient account of the product or service provider.

In the case of the electronic wallet, the permanent identification data associated therewith is useful during the upload of money on the electronic wallet. Indeed, it is necessary to have access to an account number of a financial institution, and the permanent identification data stored in the electronic wallet is used to link the electronic wallet with the electronic wallet holder's account at the financial institution. It would hence be possible for a third party to have access fraudulently to the account of a person which holds an electronic wallet if another electronic wallet is programmed with the permanent identification data of the electronic wallet of the other person, to allow access to the account of this other person.

### SUMMARY OF THE INVENTION

The present invention relates to a method for the renewal of first identification data identifying and being associated to an account hosted by a financial institution, said first identification data being stored on a PTD and at said financial institution, said method comprising the following steps:

a) communicating to said financial institution said first identification data;

b) generating second identification data which is stored at said financial institution and on said PTD, in place of said first identification data; and

c) associating said second identification data to said account of said financial institution for the purpose of ulterior identification of said account by means of said second identification data.

The present invention also relates to a method for the renewal of first identification data identifying and being associated to an account hosted by a financial institution, on the occasion of a transaction for the purchase of a product or service from a product or service provider by means of a PTD, said first identification data being stored on a PTD and at said financial institution hosting said account, said method comprising the following steps:

a) said first identification data is communicated from said PTD to an interface terminal of said product or service provider, where transaction data is accessible;

b) said transaction data and said first identification data are communicated from said terminal of said product or service provider to said financial institution;

c) said financial institution locates said account by means of said first identification data and applies said transaction data to said account;

d) said financial institution generates and stores second identification data;

e) said financial institution associates said second identification data to said account in place of said first identification data for the purpose of ulterior identification of said account by means of said second identification data;

f) said financial institution communicates said second identification data to said interface terminal of said product or service provider;

g) said interface terminal of said product or service provider transfers said second identification data to said PTD; and

h) said PTD stores said second identification data in place of said first identification data.

Preferably, in step (a), said first identification data is communicated from said PTD to said terminal of the product or service provider by means of an automated communication link, and wherein in step (g), said second identification data is communicated from said interface terminal of the product or service provider to said PTD by means of said automated communication link.

Preferably, said financial institution is provided with a terminal capable of communicating with said interface terminal of the product or service provider, and wherein in step (b), said identification data and said transaction data are communicated from said point of sales terminal to said terminal of said financial institution by means of an automated communication link, and wherein in step (f), said second identification data is communicated from said terminal of said financial institution to said terminal of said product or service provider by means of said automated communication link.

Preferably, in step (d), said generated second identification data is unique at any given moment.

Alternatively, in step (d), said generated second identification data is unique and is never reused.

Preferably, said method is accomplished automatically every time said PTD comes in communication with an interface terminal of a product or service provider.

Preferably, said method further comprises the following steps after step (h):

i) said PTD generates a message of confirmation of reception of said second identification data;

j) said PTD communicates to said interface terminal of said product or service provider said message of confirmation of reception of said second identification data; and

k) said terminal of said product or service provider communicates to said financial institution said message of confirmation of reception of said second identification data;

said method being characterized in that step (e) is accomplished only after step (k), upon reception by said financial institution of said message of confirmation of reception of said second identification data.

Preferably, Method according to claim 2, wherein at least two sets of first identification data are stored on said PTD, each set of identification data identifying and being associated to a distinct corresponding account, said method being applicable for the independent renewal of each set of first identification data according to steps (a) to (h).

The present invention also relates to a method for the renewal of first identification data identifying and being associated to an account hosted by a financial institution, on the occasion of a transaction for the purchase of a product or service from a product or service provider by means of a PTD held by a holder of said PTD, said first identification data being stored on said PTD and at said financial institution hosting said account, said method comprising the following steps:

a) said first identification data is communicated from said PTD to said holder of said PTD;

b) said first identification data is communicated from said holder of said PTD to said product or service provider, where transaction data is accessible;

c) said transaction data and said first identification data are communicated from said product or service provider to said financial institution;

d) said financial institution locates said account by means of said first identification data and applies said transaction data to said account;

e) said financial institution generates and stores second identification data and generates a transaction code associated to said second identification data;

f) said financial institution associates said second identification data to said account in place of said first identification data for the purpose of ulterior identification of said account by means of said second identification data;

g) said financial institution communicates said transaction code to said product or service provider;

h) said product or service provider transfers said transaction code to said holder of said PTD;

i) said holder of said PTD communicates said transaction code to said PTD; and

j) said PTD generates said second identification data on the basis of said transaction code and stores said second identification data in place of said first identification data.

Preferably, in step (a), said first identification data is communicated from said PTD to said holder of said PTD by interface means provided on said PTD.

Preferably, in step (a), said first identification data is communicated from said PTD to said holder of said PTD by a display screen provided on said PTD.

Preferably, in step (b) said first identification data is communicated verbally from said holder of said PTD to said product or service provider, and wherein in step (h) said transaction code is communicated verbally from said product or service provider to said holder of said PTD.

Preferably, the holder of the PTD and said product or service provider are provided with respective terminals capable of communicating with each other, and wherein in step (b) said first identification data is communicated by means of an automated communication link from said holder of said PTD to said product or service provider, and wherein in step (h) said transaction code is communicated from said product or service provider to said holder of said PTD by means of said automated communication link.

Preferably, said product or service provider and said financial institution are provided with respective terminals capable of communicating with each other, and wherein in step (c), said first identification data is communicated by means of an automated communication link from said product or service provider to said financial institution, and wherein in step (g), said transaction code is communicated from said financial institution to said product or service provider by means of said automated communication link.

Preferably, in step (e), said generated second identification data is unique at any given moment.

Alternatively, in step (e), said generated second identification data is unique and is never reused.

The present invention also relates to a method for the renewal of first identification data identifying and being associated to an account hosted by a financial institution, on the occasion of a transaction consisting in uploading transaction data to a PTD to store it thereon, said first identification data being stored on said PTD and at said financial institution hosting said account, said method comprising the following steps:

a) said first identification data is communicated from said PTD to an interface machine, a transaction request being accessible on said interface machine;

b) said transaction request and said first identification data are communicated from said interface machine to said financial institution;

c) said financial institution locates said account by means of said first identification data and applies said transaction request to said account, generating transaction data;

d) said financial institution generates and stores second identification data;

e) said financial institution associates said second identification data to said account in place of said first identification data for the purpose of ulterior identification of said account by means of said second identification data;

f) said financial institution communicates said second identification data and said transaction data to said interface machine;

g) said interface machine transfers said second identification data and said transaction data to said PTD; and

h) said PTD stores said second identification data in place of said first identification data and stores said transaction data.

Preferably, in step (d), said generated second identification data is unique at any given time.

Alternatively, in step (d), said generated second identification data is unique and is never reused.

The present invention also relates to a system allowing the accomplishment of transactions comprising:

a financial institution hosting an account;

a PTD comprising:

an electronic chip having a memory member on which data can be read and written;

a communication device capable of establishing a temporary communication with said financial institution; and

interface means allowing the access to data stored on said electronic chip; and

dynamic identification data identifying said account and associated to said account, said dynamic identification data being stored on said electronic chip of said PTD and at said financial institution and which can be renewed both on said electronic chip of said PTD and at said financial institution.

The present invention also relates to a system allowing the accomplishment of transactions comprising:

a financial institution hosting an account;

an interface terminal capable of communicating with said financial institution and comprising a first communication device;

a PTD comprising:

an electronic chip having a memory member on which data can be read and written;

a second communication device capable of establishing a temporary communication with said first communication device of said interface terminal; and

interface means allowing the access to data stored on said electronic chip; and

dynamic identification data identifying said and associated to said account, said dynamic identification data being stored on said electronic chip of said PTD and at said financial institution and which can be renewed both on said electronic chip of said PTD and at said financial institution.

The present invention also relates to a system for the renewal of first identification data identifying and being associated to an account hosted by a financial institution, said first identification data being stored on a PTD and at said financial institution, said system comprising:

a) means for communicating to said financial institution said first identification data;

b) means for generating second identification data which is stored at said financial institution and on said PTD, in place of said first identification data; and

c) means for associating said second identification data to said account of said financial institution for the purpose of ulterior identification of said account by means of said second identification data.

The present invention also relates to a system for the renewal of first identification data identifying and being associated to an account hosted by a financial institution, on the occasion of a transaction for the purchase of a product or service from a product or service provider by means of a PTD, said first identification data being stored on a PTD and at said financial institution hosting said account, said system comprising:

a) means for said first identification data to be communicated from said PTD to an interface terminal of said product or service provider, where transaction data is accessible;

b) means for said transaction data and said first identification data to be communicated from said terminal of said product or service provider to said financial institution;

c) means for said financial institution to locate said account by means of said first identification data and to apply said transaction data to said account;

d) means for said financial institution to generate and store second identification data;

e) means for said financial institution to associate said second identification data to said account in place of said first identification data for the purpose of ulterior identification of said account by means of said second identification data;

f) means for said financial institution to communicate said second identification data to said interface terminal of said product or service provider;

g) means for said interface terminal of said product or service provider to transfer said second identification data to said PTD; and

h) means for said PTD to store said second identification data in place of said first identification data.

The present invention also relates to a system for the renewal of first identification data identifying and being associated to an account hosted by a financial institution, on the occasion of a transaction for the purchase of a product or service from a product or service provider by means of a PTD held by a holder of said PTD, said first identification data being stored on said PTD and at said financial institution hosting said account, said system comprising:

a) means for said first identification data to be communicated from said PTD to said holder of said PTD;

b) means for said first identification data to be communicated from said holder of said PTD to said product or service provider, where transaction data is accessible;

c) means for said transaction data and said first identification data to be communicated from said product or service provider to said financial institution;

d) means for said financial institution to locate said account by means of said first identification data and to apply said transaction data to said account;

e) means for said financial institution to generate and to store second identification data and to generate a transaction code associated to said second identification data;

f) means for said financial institution to associate said second identification data to said account in place of said first identification data for the purpose of ulterior identification of said account by means of said second identification data;

g) means for said financial institution to communicate said transaction code to said product or service provider;

h) means for said product or service provider to transfer said transaction code to said holder of said PTD;

i) means for said holder of said PTD to communicate said transaction code to said PTD; and

j) means for said PTD to generate said second identification data on the basis of said transaction code and to store said second identification data in place of said first identification data.

The present invention also relates to a system for the renewal of first identification data identifying and being associated to an account hosted by a financial institution, on the occasion of a transaction consisting in uploading transaction data to a PTD to store it thereon, said first identification data being stored on said PTD and at said financial institution hosting said account, said system comprising:

a) means for said first identification data to be communicated from said PTD to an interface machine, a transaction request being accessible on said interface machine;

b) means for said transaction request and said first identification data to be communicated from said interface machine to said financial institution;

c) means for said financial institution to locate said account by means of said first identification data and to apply said transaction request to said account, generating transaction data;

d) means for said financial institution to generate and to store second identification data;

e) means for said financial institution to associate said second identification data to said account in place of said first identification data for the purpose of ulterior identification of said account by means of said second identification data;

f) means for said financial institution to communicate said second identification data and said transaction data to said interface machine;

g) means for said interface machine to transfer said second identification data and said transaction data to said PTD;

h) means for said PTD to store said second identification data in place of said first identification data and to store said transaction data.

The present invention also relates to a PTD comprising an electronic chip, interface means linked to said electronic chip, a communication device linked to said electronic chip to allow said PTD to communicate with an interface machine provided with a complementary communication device, said electronic chip comprising at least a memory member which can be read and on which data can be stored, said memory member including at least identification data identifying and associated to an account hosted in a financial institution, said identification data being renewable.

The present invention also relates to a method for the renewal of identification data identifying and being associated to an account hosted by a financial institution, said identification data being stored on a PTD and at said financial institution, said method including the step of the renewal of identification data which comprises the following sub-steps:

a) erasing said identification data on said PTD and at said financial institution;

b) generating new identification data;

c) storing said new identification data both on said PTD and at said financial institution; and

d) associating said new identification data to said account hosted by said financial institution for the purpose of ulterior identification of said account by means of said new identification data;

said step of renewal being accomplished every time a determined condition is respected.

Preferably, the method is accomplished on the occasion of transactions, and wherein said determined condition is that a transaction be accomplished.

Preferably, the method is accomplished on the occasion of transactions, and wherein said PTD communicates in a temporary fashion with said financial institution through the instrumentality of an interface machine when a transaction must be accomplished, and wherein said determined condition is that a communication must be established between said PTD and said financial institution through the instrumentality of said interface machine.

### DESCRIPTION OF THE DRAWINGS

In the annexed drawings:

FIG. 1 schematically shows a system for performing a transaction by means of a PTD having dynamic identification data;

FIGS. 2a and 2b schematically and sequentially show the data progression within a system similar to that shown in FIG. 1;

FIGS. 3a and 3b schematically and sequentially show the data progression within a system for performing a transaction by means of a PTD having dynamic identification data, and where the PTD does not come in communication with an interface machine;

FIGS. 4a and 4b schematically and sequentially show the data progression within a system for performing a transaction by means of a PTD having dynamic identification data, and where the transaction consists of uploading transaction data to the PTD; and

FIGS. 5a and 5b schematically and sequentially show the data progression within a system for performing a transaction by means of a PTD having dynamic identification data, and where the transaction is made using a PTD loaded beforehand with transaction data.

### DETAILED DESCRIPTION OF THE EMBODIMENTS

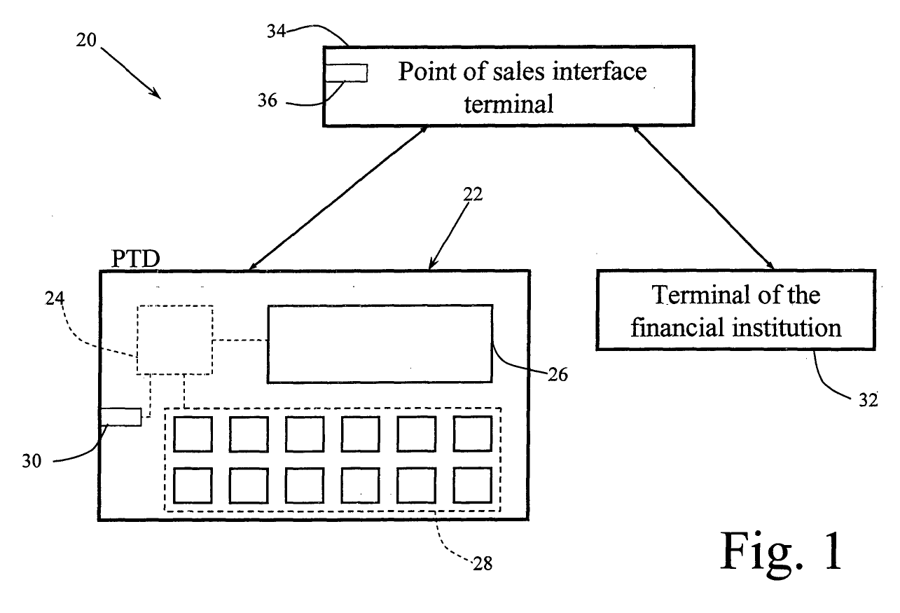

FIG. 1 shows a system 20 for performing a transaction by means of a PTD having dynamic identification data.

System 20 comprises a PTD 22 which comprises an electronic chip 24 connected to a display screen 26, a keyboard 28 and a communication device 30. Electronic chip 24 comprises at least one memory member which can be read and on which data can be stored. Identification data is stored in the memory member of chip 24. This identification data can be a number comprising a series of digits, or alternatively any other form of data which can be used for identifying an account associated with the PTD in a financial institution 32. PTD 22 can be a debit card, a credit card, an electronic wallet, or any other portable transaction device comprising identification data associated with an account in a financial institution.

According to the invention, PTD 22 can establish communication with a point of sales interface terminal 34 of a product or service provider. This communication is established by means of communication device 30 located on PTD 22 and by means of a second communication device 36 which is located on the point of sales interface terminal 34. Communication devices 30, 36 are complementary to each other, and allow to establish a temporary communication between PTD 22 and point of sales interface terminal 34 for data exchange. Communication devices 30, 36 can be, for example, optical emitter-transmitter sets which allow data exchange via infrared waves; or else radio wave emitter-transmitter sets; or else any other suitable set of emitter-transmitter allowing data exchange, with or without direct link between PTD 22 and point of sales interface terminal 34.

Point of sales interface terminal 34 can establish communication with the terminal of financial institution 32 according to other known wire or wireless means, for example through the instrumentality of a computer network such as Internet. This communication can be established in a punctual fashion, when need be, or can remain active permanently.

The identification data stored in chip 24 can be displayed on display screen 26 either in a permanent way, or only when needed by the PTD holder when the latter commands the PTD to display the identification data through keyboard 28. Thus, the PTD holder can visually verify his identification data at any time. Other data can also be stored on chip 24 and displayed on screen 26, for example the expiration date of the PTD if any, the PTD holder's name, etc. As mentioned, at least the identification data can be replaced and modified.

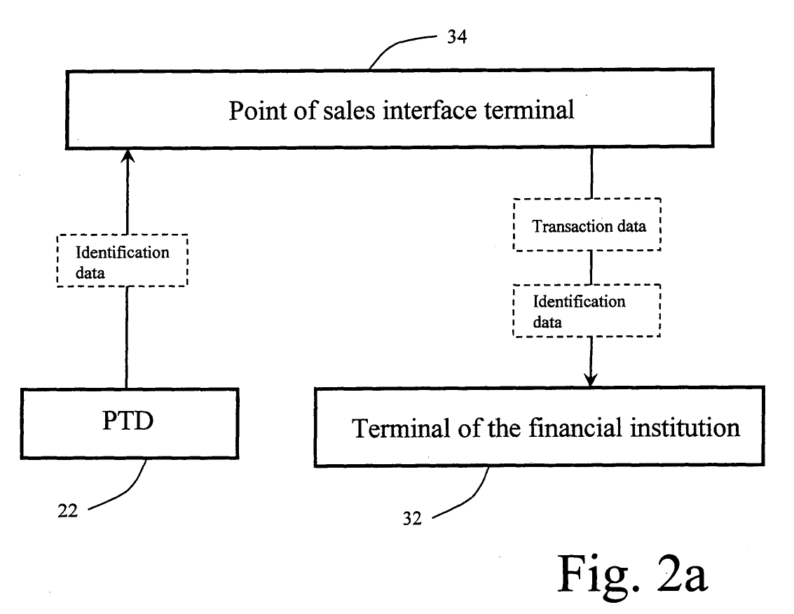

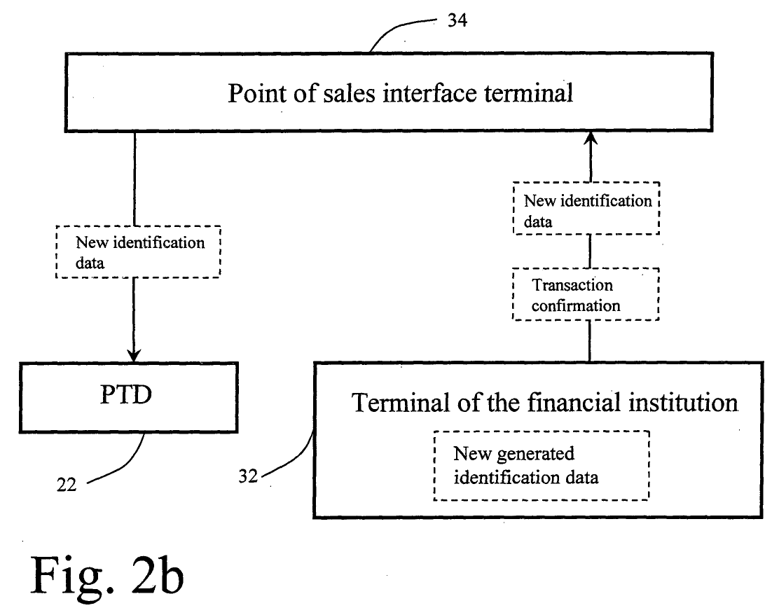

FIGS. 2a and 2b schematically illustrate the data exchange sequence between PTD 22, point of sales interface terminal 34 of a product or service provider, and the terminal of a financial institution 32, and more particularly how the identification data of PTD 22 can be renewed on the occasion of a transaction for the purchase of a product or service, according to a first embodiment of the invention. The identification data identifies and is associated with an account hosted by financial institution 32.

When the holder of PTD 22 wants to purchase a product or a service, transaction data is communicated to point of sales interface terminal 34. This transaction data can be, for example, the price of the product or service which is wanted for purchase. This transaction data can be communicated to point of sales interface terminal 34 in any known acceptable way, for example by means of a computer link between the interface terminal and an electronic cash register (not shown), or else by means of a keyboard (not shown) provided on the interface terminal 34 which allows to dial the transaction data on this keyboard to communicate it to interface terminal 34.

As shown in FIG. 2a, once the transaction data has been communicated to point of sales interface terminal 34, the identification data of PTD 22 is transmitted from PTD 22 to point of sales interface terminal 34. Thereafter, this identification data is transmitted from point of sales interface terminal 34 to the interface terminal of financial institution 32, along with the transaction data. The interface terminal of the financial institution can thus, in a conventional manner, apply to the account of the holder of PTD 22 the transaction data in a suitable fashion, for example by debiting the account with the amount of the purchased product or service. The account of the holder of PTD 22 is located thanks to the identification data associated with that account, in a manner which is also known.

Moreover, as shown in FIG. 2b, the terminal of financial institution 32 generates new identification data. This new identification data is stored by the terminal of financial institution 32, and is associated with the account of the holder of PTD 22, by replacing the old identification data. In other words, the old identification data which has just been used to locate the account of the holder of PTD 22 to apply the transaction data thereto—this old identification data, hence, is erased and replaced by newly generated identification data, and this new identification data is associated with the account of the holder of PTD 22, so that, this account be associated in the future only with this new identification data.

Once the new identification data has been created and associated with the account of the holder of PTD 22, it is transmitted to point of sales interface terminal 34, with the confirmation that the transaction has been accepted. Despite the fact that this confirmation message is not necessary, it is usual to issue it to confirm that the transaction data has been correctly applied to the account of the holder of PTD 22. Point of sales interface terminal 34 transmits in turn the new identification data to PTD 22, which stores it on its chip 24 by replacing the old identification data. Hence, the old identification data is erased from PTD 22, and only the new identification data remain stored thereon. Subsequently, the identification data of PTD 22 which is displayed on screen 26 will be the new identification data, which have been transmitted by the terminal of financial institution 32 through the instrumentality of point of sales interface terminal 34.

It is understood that the terminal of the financial institution 32 can perform usage verifications concerning the validity of the account of the holder of PTD 22 and concerning the conditions necessary for the transaction, according to the transaction data transmitted by point of sales interface terminal 34, to be approved. For example, when it comes to an account related to a credit card, the terminal of the financial institution will verify particularly if the credit limit associated with the account of the holder of PTD 22 will not be exceeded if the transaction is applied to this account. It goes without saying that the transaction confirmation message will be transmitted only if the transaction is actually approved by the terminal of financial institution 32 according to the conditions associated with the account of the holder of PTD 22. As regards the generation and transmission of new identification data associated with the account of the holder of PTD 22, according to a first alternative, this will be accomplished only if the transaction is approved; according to a second alternative, new identification data is generated and transmitted even if the transaction is not approved.

Thus, according to an embodiment of the invention shown in FIGS. 2a and 2b, every time the holder of PTD 22 performs a transaction via an interface terminal 34 which can communicate with the terminal of the financial institution 32, new identification data associated with his account hosted by financial institution 32, is generated by replacing the old identification data, and is stored at the terminal of financial institution 32 and on PTD 22. Thus, the identification data of PTD 22 becomes obsolete as soon as it is used to perform a transaction through the instrumentality of an interface machine. In the present specification, identification data thus renewable on PTD 22 is called “dynamic identification data”.

The point of having such dynamic identification data on the PTD 22 is that it becomes very difficult, not to say impossible, to apply fraudulently a transaction to the account of the holder of PTD 22 hosted by financial institution 32 by the unauthorized usage of the identification data of PTD 22 which would have been obtained by a third party thanks to the transmission of this identification data on the occasion of a transaction, and without the holder of PTD 22 knowing it. Indeed, if a third party becomes aware of the identification data of PTD 22 of another person and if this data is obtained because the identification data is transmitted on the occasion of a transaction made by the holder of PTD 22, once this transaction has ended, the identification data is already replaced by the new identification data, and the account of the holder of PTD 22 cannot be accessed by means of the old identification data.

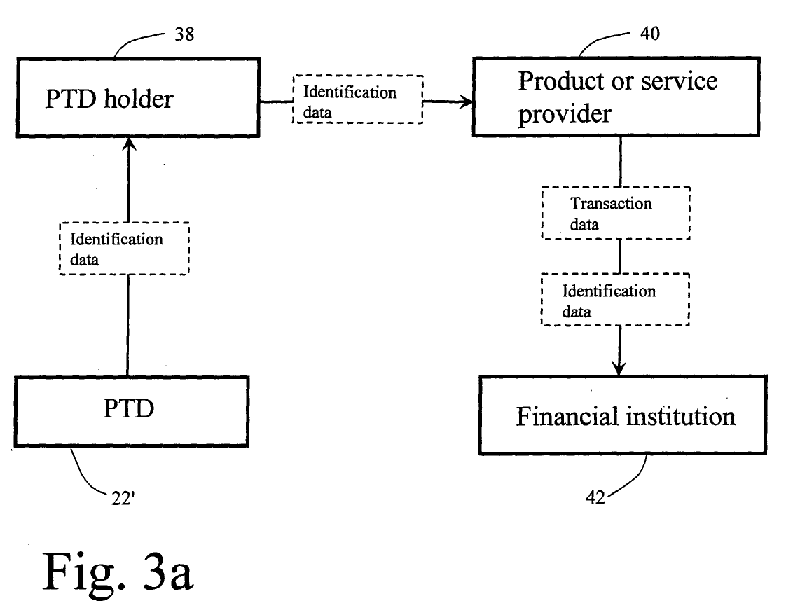

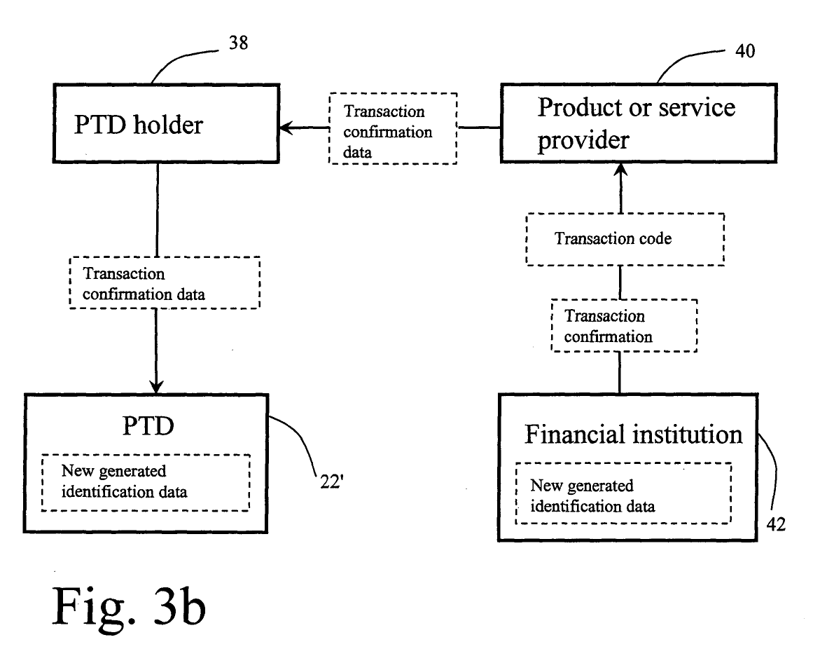

FIGS. 3a and 3b show a second embodiment of the invention, by which it is not necessary that the PTD 22′ be in communication with a point of sales interface terminal in order for the transaction to be accomplished and for new identification data to be generated and associated with the account of the holder of PTD 22′ hosted by a financial institution 42. This is desirable to perform transactions when a point of sales interface terminal is not available, for example if the transaction is made by telephone, or also via a computer network such as Internet by means of a computer which is not provided with a suitable interface machine allowing the PTD to communicate with the computer.

According to the embodiment of FIGS. 3a and 3b, the holder 38 of PTD 22′ comes into communication with a product or service provider 40 to purchased a product or a service. This communication can be of any appropriate form, for example by telephone or by means of an automated communication link such as via Internet through the instrumentality of a computer. Transaction data associated with this product or service, for example the price of the product or service, is communicated with the product or service provider 40, in an appropriate fashion.

The product or service provider 40 can, for his part, communicate with financial institution 42 by known means. This communication can for example be made verbally by telephone with an attendant of financial institution 42, or also by means of a point of sales terminal (not shown) which can come in communication with a terminal of the financial institution (not shown) via a computer network such as Internet. The product or service provider 40 can hence be represented by a person or even a machine such as a computer; or also by the combination of the two, where a person would receive communications from the holder of PTD and would transmit the appropriate data to a terminal of the financial institution by means of a terminal of the product or service provider.

As illustrated in FIG. 3a, PTD 22′ communicates first, by means of its display screen, the identification data of PTD 22′ to holder of the PTD 38. Holder of the PTD 38 then transmits this identification data to product or service provider 40 through the instrumentality of communication means which links them to each other. In turn, product or service provider 40 transmits identification data to financial institution 42, along with the transaction data, the latter being for example the price of the product or service that holder of the PTD 38 wishes to buy.

Thereafter, as illustrated in FIG. 3b, financial institution 42 generates new identification data. This new identification data is stored by financial institution 42, and is associated with the account of the holder of PTD 22′, by replacing the old identification data, which hence becomes obsolete and which, from that moment on, cannot be used to access the account of the holder of PTD 22′. Financial institution 42 also generates a transaction code which is transmitted, along with a transaction confirmation message, to product provider 40. This transaction code can be, for example, a sequence of digits or letters, or any other data of suitable form. The transaction code must then be transmitted from product provider 40 to holder of the PTD 38, which communicates this transaction code to PTD 22′, for example by dialing it on keyboard 28 of PTD 22′. Once this transaction code is entered in PTD 22′, the latter, by means of pre-installed software installed in its chip 24 according to the present embodiment of the invention, will generate new identification data and will store it by replacing the old identification data, which hence disappears completely from the memory of PTD 22′.

It is understood that the software provided in the chip of PTD 22′ is provided for generating the same identification data than that generated by financial institution 42 for a same transaction code. For example, a way of accomplishing this is that the software of PTD 22′ comprises a table in which a large amount of transaction codes are associated to corresponding identification data, and that financial institution 42 possesses this table as well. Thus, when the transaction code is generated by the financial institution, the latter will associate to the account of the holder of PTD 22′ the identification data which corresponds in the table to the generated transaction code, and PTD 22′ will do the same, the identification data of PTD 22′ being thus the same than that associated with the account of the holder of PTD 22′ at financial institution 42. Thus, financial institution 42 generates both a transaction code and new identification data, but either the transaction code, or the identification data, is imposed by the choice of the other.

Other appropriate software can also be used to associate a transaction code to identification data. For example, if the transaction code and the identification data are all numerical values, an arithmetical calculation can be applied to one of both values to obtain the second, for example to generate an identification number from a transaction code. The same arithmetical calculation being accomplished on the transaction code both at the financial institution (e.g. on a terminal of the financial institution) and in the chip of PTD 22′, it is understood that the new identification number associated with the account of the holder of PTD 22′ will be the same at the financial institution and on PTD 22′.

According to this embodiment of the invention, the identification data can hence be changed on the PTD without the latter being in communication with any interface machine.

It is to be noted that a transaction similar to that illustrated in FIGS. 2a and 2b could be accomplished by transmitting a transaction code to the PTD instead of identification data, as mentioned hereinabove. Indeed, according to the present invention, the transmission of a transaction code is not only for the exclusive situation where the PTD can not be put in communication with an point of sales interface terminal by means of an automated communication link, such as an interface machine capable of electronically communicating with the PTD. Thus, according to this other embodiment (not shown), a transaction code would be issued by the terminal of the financial institution and sequentially transmitted to the point of sales terminal and to the PTD, the PTD then generating new identification data as mentioned hereinabove on the basis of the received transaction code. This latter embodiment has the advantage of preventing that the identification data be intercepted during their transmission between the terminal of the financial institution and the PTD, for example by means of a computer hack. Only the transaction code is issued and transmitted to the PTD, this transaction code allowing the PTD to generate new identification data.

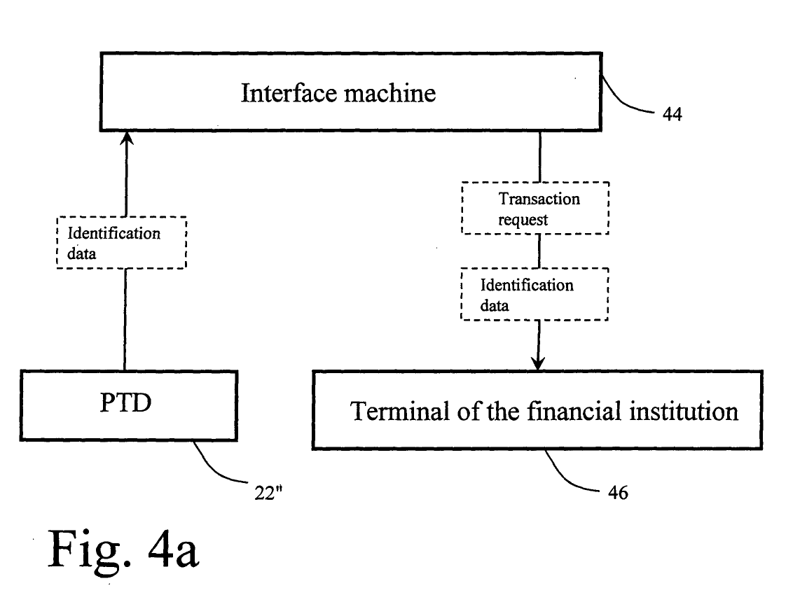

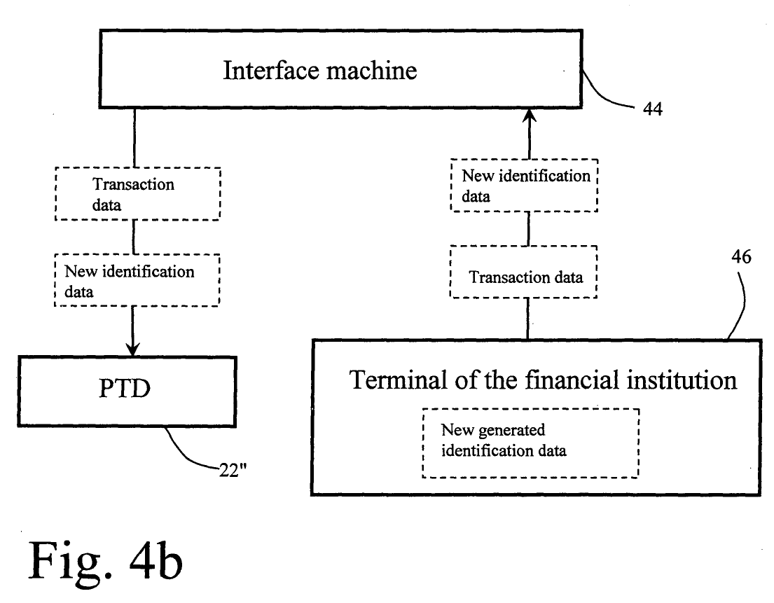

FIGS. 4a and 4b show another embodiment of the invention, in which PTD 22″ can come in communication with an interface machine 44 which in turn can communicate with the terminal of a financial institution 46. In the embodiment of FIGS. 4a and 4b, PTD 22″ can be loaded with certain transaction data, for example a certain amount of electronic money. An example of a known form of PTD which can be loaded with an amount of electronic money, is the electronic wallet, in which an amount of money can be transferred from an account of a financial institution. The expression “electronic money” means that the money is transferred only in the form of data. With a such PTD 22″ which is charged with electronic money, when ulterior transactions occur, PTD 22″ can be linked directly to an appropriate interface machine and transfer this money loaded on PTD 22″ to a product or service provider in exchange for a product or service.

As illustrated in FIG. 4a, the identification data of the account of the holder of PTD 22″ is transferred first from PTD 22″ to interface machine 44. Interface machine 44 can be, for example, an automatic teller machine, a computer provided with a communication device 36, or any other machine capable of communicating with PTD 22″. In addition, the interface machine can be used by the holder of PTD 22″ to indicate his transaction request, for example a request for a monetary withdrawal from his account to load this amount of money on his PTD 22″. Alternatively, the transaction request can be indicated directly on PTD 22″, this transaction request being then transmitted first to interface machine 44 along with the identification data. Interface machine 44 thereafter transmits the identification data, accompanied by the transaction request, to the terminal of financial institution 46.

As illustrated in FIG. 4b, the terminal of the financial institution 46 then applies the transaction request to the account associated to the identification data, for example by debiting the user's account with the requested amount of money, and generates new identification data which is associated with the account of the holder of PTD 22″. This new identification data is stored in place of the old identification data which has been used to apply the requested transaction, and the old identification data hence become obsolete and cannot from that moment on be further used to access the account of the holder of PTD 22″.

The new identification data, as well as the transaction data which can be for example the debited amount of electronic money, is afterwards transmitted from the terminal of financial institution 46 to interface machine 44, and to PTD 22″ where the transaction data is applied (for example the amount of money loaded onto chip 24 of PTD 22″). Moreover, the new identification data is recorded on chip 24 instead of the old identification data, which is erased.

Thus, if a third party becomes aware of the identification data of the PTD 22″, it is not possible for it to use it after a loading transaction of PTD 22″ has taken place since the identification data of PTD 22″ is renewed every time PTD 22″ is loaded with an amount of money. It does not become possible to fraudulently access the account of the holder of PTD 22″ to withdraw money using the old identification data.

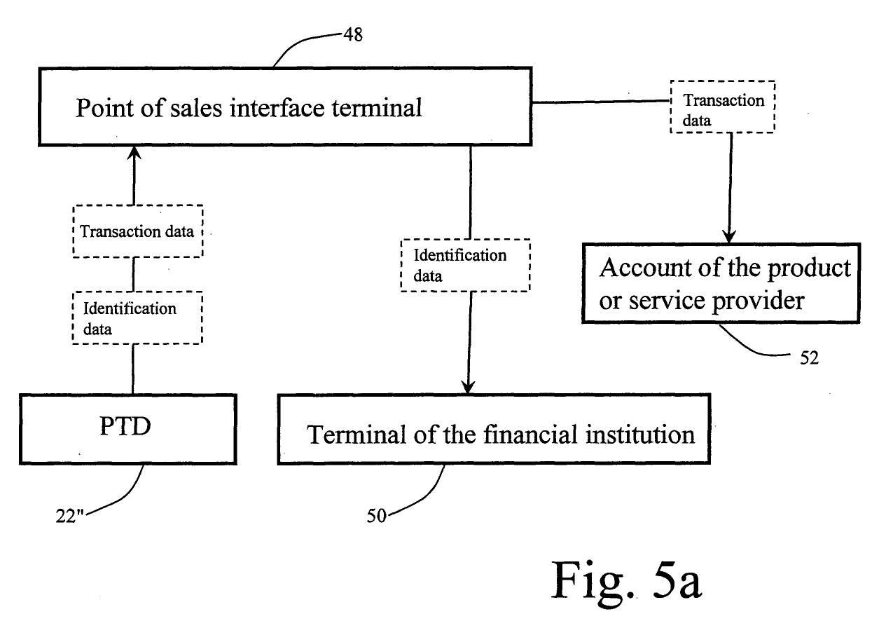

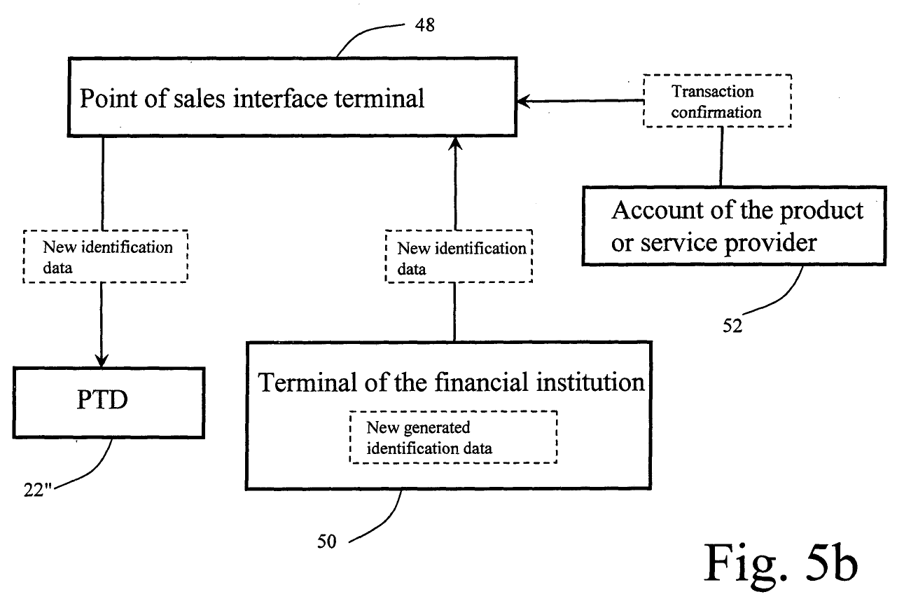

FIGS. 5a and 5b show how PTD 22″ of FIGS. 4a and 4b, which can be for example an electronic wallet, once it is loaded with transaction data, which can for example be an amount of money, can be used to accomplish a transaction such as the purchase of a product or service, its identification data being simultaneously renewed. To do so, the product or service provider is provided with a point of sales interface terminal 48 which can communicate with PTD 22″ and also with the terminal of financial institution 50 which hosts the account associated to the holder of PTD 22″.

FIG. 5a shows that the identification data is first transmitted from PTD 22″ to point of sales interface terminal 48, along with the transaction data which can for example be the amount of electronic money disbursed from PTD 22″ for the purchase of a product or service. Point of sales interface terminal 48 transmit in turn the identification data to the terminal of financial institution 50, and conveys to a suitable account of the product or service provider 52 the transaction data downloaded from the card. This account 52 can be located on an electronic wallet, in another financial institution, or at any appropriate and conventional location.

Financial institution 50 locates the account of the holder of PTD 22″ using the identification data, generates new identification data, stores it and associates it with the account of the holder of PTD 22″, erasing the old identification data.

As illustrated in FIG. 5b, the new identification data is then transmitted from PTD 22″ via point of sales interface terminal 48, and this data is stored on chip 24 of PTD 22″ instead of the old identification data. A transaction confirmation message can also come from an administrator (for example a person or a terminal) from the account of the product or service provider 52, indicating that the transaction data has been correctly received in the account.

Thus, according to this embodiment of the invention, the identification data of PTD 22″ is renewed during the transfer of the transaction data (for example the money), but without the terminal of financial institution 50 being directly involved in the transaction as such, which rather involves PTD 22″, the account of the product or service provider 52 and point of sales interface terminal 48. Indeed, the only data exchanged between point of sales interface terminal 48 and the terminal of the financial institution 50 is the identification data of the PTD 22″.

It is understood that for all the embodiments of the present invention, appropriate security methods can be used, and that at more than one level.

For example, to ensure that the PTD has correctly received the new identification data by replacing the old identification data, the terminal of the financial institution or the financial institution can await the reception of an identification data reception confirmation message from the PTD before applying the new identification data to the account of the holder of the PTD hosted at the financial institution. This will prevent that the account of the holder of the PTD sees the identification data associated therewith as being renewed, whereas the PTD keeps the old identification data, which would actually stop the holder of the PTD from accomplishing ulterior transaction by means of his PTD. That latter situation could occur for example if a communication problem occurs after the issue of the new identification data by the terminal of the financial institution but before the reception of this new identification data by the PTD, this communication problem preventing the PTD from receiving the new identification data.

Also, suitable cryptographic or codification methods could be used in order to prevent the data and messages transmitted between the PTD, the point of sales interface terminal and the terminal of the financial institution, from being inspected without them being appropriately decoded.

Moreover, security means to prevent an unauthorized usage of the PTD can be used, for example a personal identification code which needs to be dialed on the keyboard of the PTD before the latter can be used, or also the detection of a biometric parameter by a suitable detector provided on the PTD, such as a fingerprint detector or an eye retina scan apparatus.

In addition, it is understood that even if the PTD has been illustrated and described until now as being provided with a keyboard and a display screen, other interface means between the PTD and its holder are also envisioned. For example, provision can be made for a sound receiver-transmitter set, as well as a voice-recognition software located in the chip of the PTD, which would allow the holder of the PTD to verbally communicate with his PTD. Or also the PTD could be provided with a Braille interface to indicate to its holder the information the latter is trying to obtain. These two latter methods have the advantage of allowing visually impaired people to perform transactions using the PTD.

It is also possible that the interface means allowing access to the information located within the chip of the PTD be separated from the PTD itself. For example, provision can be made for an interface machine specifically devised to allow access to the data of the PTD and its display.

The PTD can also combine in one sole device all the characteristics of the PTD of the embodiments described in the present patent application. In other words, one sole PTD could be used to perform a transaction to purchase a product or service, where the account of the holder is hosted by a financial institution and is directly debited via a point of sales interface terminal as illustrated in FIGS. 2a and 2b, or via the intervention of the holder of the PTD as illustrated in FIGS. 3a and 3b; or also where the account of the holder is hosted on the PTD itself as illustrated in FIGS. 5a and 5b; or finally where the account of the holder is hosted by the financial institution and is debited via an interface machine, to load the PTD with transaction data as illustrated in FIGS. 4a and 4b. It is understood that such a PTD could have access to at least two different accounts, namely the one located at the financial institution of the holder of the PTD and that located on the PTD itself which is represented by the digitized form of money loaded onto the PTD, and hence a software located on the electronic chip 24 of the PTD must allow his holder to choose which account he wishes to access, this choice being accomplished through the instrumentality of the interface means of the PTD, for example keyboard 28 and display screen 26.

It is also envisioned that the PTD could be used to access more than one account located in one or more financial institution. Once again, a software located on chip 24 of the PTD must allow for its holder to choose which account he wishes to access through the instrumentality of suitable interface means. The same dynamic identification data or respective dynamic identification data can be associated with each account.

It is also possible that the dynamic identification data of the PTD be combined to permanent identification data. For example, if the PTD a credit smart card, the same credit company could issue PTDs having a first portion of identification data in the form of a few digits identifying the credit company, this first portion being never modified and representing henceforth permanent identification data. A second part of the identification data could be dynamic identification data, and the combination of the two dynamic and permanent portions would form the identification data of the PTD. Thus, only one part of the credit card number would be formed by dynamic identification data.

It is also envisioned that the identification data of the PTD could be renewed without a transaction taking place, for example if the holder of the PTD has reasons to believe that the identification data of his PTD has become known by others and wishes, as a preventive measure, to renew the identification data of his account. Thus, the holder of the PTD could, through the instrumentality of a suitable interface machine, for example an automatic teller machine or any other suitable public or private interface machine, renew the identification data of his account and store the new identification data on his PTD with a method similar to one of the methods illustrated in FIGS. 2a, 2b; 3a, 3b; 4a, 4b; or 5a, 5b, with the difference that no transaction takes place. The only data transfer which would then occur would be related to the identification data, and also to the transaction code in the case of the embodiment of FIGS. 3a, 3b.

In a general manner, the identification data of the PTD can be renewed when one or many conditions are respected, either at every transaction made through the instrumentality of an interface machine, every time a PTD is loaded with transaction data, every time any sort of communication (verbal or automated) can be established between the PTD and the financial institution, on demand only, every time a time interval has been elapsed, every time a determined number of transactions has been performed, etc.

According to an embodiment of the invention, the identification data associated with an account is unique at any given moment. Alternatively, the identification data associated with an account is unique and is never reused as is.

According to an embodiment of the invention, the electronic chip provided on the PTD stores in its memory the transactions accomplished therewith, until a maximal number of transactions which can be determined for example according to the memory capacity of the electronic chip. Thus, it is possible to upload, for example to a personal computer, all the data concerning the transactions accomplished by means of the PTD. In this fashion, the management of the operations accomplished by means of the PTD is facilitated.

According to an embodiment of the invention, the identification data can be a code allowing the access to the holder of the PTD beyond a gate provided with a security device which necessitates that valid identification data be provided thereto in order for the access beyond the gate be authorized. Thus, in such a case, “the financial institution” would be in fact the institution which manages the identification numbers. It is hence understood that the expression “financial institution”, in the present document, is not limited to an institution managing monetary accounts, but actually to a institution which manages any accounts, for example accounts of identification data serving as access codes. It can thus be seen that even if the present invention is applicable to monetary transactions, it is not at all limited to such applications.

1. Method for the renewal of first identification data identifying and being associated to an account hosted by a financial institution, said first identification data being stored on a PTD and at said financial institution, said method comprising the following steps:
a) communicating to said financial institution said first identification data;
b) generating second identification data which is stored at said financial institution and on said PTD, in place of said first identification data; and
c) associating said second identification data to said account of said financial institution for the purpose of ulterior identification of said account by means of said second identification data.

2. Method for the renewal of first identification data identifying and being associated to an account hosted by a financial institution, on the occasion of a transaction for the purchase of a product or service from a product or service provider by means of a PTD, said first identification data being stored on a PTD and at said financial institution hosting said account, said method comprising the following steps:
a) said first identification data is communicated from said PTD to an interface terminal of said product or service provider, where transaction data is accessible;
b) said transaction data and said first identification data are communicated from said terminal of said product or service provider to said financial institution;
c) said financial institution locates said account by means of said first identification data and applies said transaction data to said account;
d) said financial institution generates and stores second identification data;
e) said financial institution associates said second identification data to said account in place of said first identification data for the purpose of ulterior identification of said account by means of said second identification data;
f) said financial institution communicates said second identification data to said interface terminal of said product or service provider;
g) said interface terminal of said product or service provider transfers said second identification data to said PTD; and
h) said PTD stores said second identification data in place of said first identification data.

3. Method according to claim 2, wherein in step (a), said first identification data is communicated from said PTD to said terminal of the product or service provider by means of an automated communication link, and wherein in step (g), said second identification data is communicated from said interface terminal of the product or service provider to said PTD by means of said automated communication link.

4. Method according to claim 2, wherein said financial institution is provided with a terminal capable of communicating with said interface terminal of the product or service provider, and wherein in step (b), said identification data and said transaction data are communicated from said point of sales terminal to said terminal of said financial institution by means of an automated communication link, and wherein in step (f), said second identification data is communicated from said terminal of said financial institution to said terminal of said product or service provider by means of said automated communication link.

5. Method according to claim 2, wherein in step (d), said generated second identification data is unique at any given moment.

6. Method according to claim 2, wherein in step (d), said generated second identification data is unique and is never reused.

7. Method according to claim 2, wherein said method is accomplished automatically every time said PTD comes in communication with an interface terminal of a product or service provider.

8. Method according to claim 2, further comprising the following steps after step (h):
i) said PTD generates a message of confirmation of reception of said second identification data;
j) said PTD communicates to said interface terminal of said product or service provider said message of confirmation of reception of said second identification data; and
k) said terminal of said product or service provider communicates to said financial institution said message of confirmation of reception of said second identification data;
said method being characterized in that step (e) is accomplished only after step (k), upon reception by said financial institution of said message of confirmation of reception of said second identification data.

9. Method according to claim 2, wherein at least two sets of first identification data are stored on said PTD, each set of identification data identifying and being associated to a distinct corresponding account, said method being applicable for the independent renewal of each set of first identification data according to steps (a) to (h).

10. Method for the renewal of first identification data identifying and being associated to an account hosted by a financial institution, on the occasion of a transaction for the purchase of a product or service from a product or service provider by means of a PTD held by a holder of said PTD, said first identification data being stored on said PTD and at said financial institution hosting said account, said method comprising the following steps:
a) said first identification data is communicated from said PTD to said holder of said PTD;
b) said first identification data is communicated from said holder of said PTD to said product or service provider, where transaction data is accessible;
c) said transaction data and said first identification data are communicated from said product or service provider to said financial institution;
d) said financial institution locates said account by means of said first identification data and applies said transaction data to said account;
e) said financial institution generates and stores second identification data and generates a transaction code associated to said second identification data;
f) said financial institution associates said second identification data to said account in place of said first identification data for the purpose of ulterior identification of said account by means of said second identification data;
g) said financial institution communicates said transaction code to said product or service provider;
h) said product or service provider transfers said transaction code to said holder of said PTD;
i) said holder of said PTD communicates said transaction code to said PTD; and
j) said PTD generates said second identification data on the basis of said transaction code and stores said second identification data in place of said first identification data.

11. Method according to claim 10, wherein in step (a), said first identification data is communicated from said PTD to said holder of said PTD by interface means provided on said PTD.

12. Method according to claim 11, wherein in step (a), said first identification data is communicated from said PTD to said holder of said PTD by a display screen provided on said PTD.

13. Method according to claim 10, wherein in step (b) said first identification data is communicated verbally from said holder of said PTD to said product or service provider, and wherein in step (h) said transaction code is communicated verbally from said product or service provider to said holder of said PTD.

14. Method according to claim 10, wherein the holder of the PTD and said product or service provider are provided with respective terminals capable of communicating with each other, and wherein in step (b) said first identification data is communicated by means of an automated communication link from said holder of said PTD to said product or service provider, and wherein in step (h) said transaction code is communicated from said product or service provider to said holder of said PTD by means of said automated communication link.

15. Method according to claim 10, wherein said product or service provider and said financial institution are provided with respective terminals capable of communicating with each other, and wherein in step (c), said first identification data is communicated by means of an automated communication link from said product or service provider to said financial institution, and wherein in step (g), said transaction code is communicated from said financial institution to said product or service provider by means of said automated communication link.

16. Method according to claim 10, wherein in step (e), said generated second identification data is unique at any given moment.

17. Method according to claim 10, wherein in step (e), said generated second identification data is unique and is never reused.

18. Method for the renewal of first identification data identifying and being associated to an account hosted by a financial institution, on the occasion of a transaction consisting in uploading transaction data to a PTD to store it thereon, said first identification data being stored on said PTD and at said financial institution hosting said account, said method comprising the following steps:
a) said first identification data is communicated from said PTD to an interface machine, a transaction request being accessible on said interface machine;
b) said transaction request and said first identification data are communicated from said interface machine to said financial institution;
c) said financial institution locates said account by means of said first identification data and applies said transaction request to said account, generating transaction data;
d) said financial institution generates and stores second identification data;
e) said financial institution associates said second identification data to said account in place of said first identification data for the purpose of ulterior identification of said account by means of said second identification data;
f) said financial institution communicates said second identification data and said transaction data to said interface machine;
g) said interface machine transfers said second identification data and said transaction data to said PTD; and
h) said PTD stores said second identification data in place of said first identification data and stores said transaction data.

19. Method according to claim 18, wherein in step (d), said generated second identification data is unique at any given time.

20. Method according to claim 18, wherein in step (d), said generated second identification data is unique and is never reused.

21. System allowing the accomplishment of transactions comprising:
a financial institution hosting an account;
a PTD comprising:
an electronic chip having a memory member on which data can be read and written;
a communication device capable of establishing a temporary communication with said financial institution; and
interface means allowing the access to data stored on said electronic chip; and
dynamic identification data identifying said account and associated to said account, said dynamic identification data being stored on said electronic chip of said PTD and at said financial institution and which can be renewed both on said electronic chip of said PTD and at said financial institution.

22. System allowing the accomplishment of transactions comprising:
a financial institution hosting an account;
an interface terminal capable of communicating with said financial institution and comprising a first communication device;
a PTD comprising:
an electronic chip having a memory member on which data can be read and written;
a second communication device capable of establishing a temporary communication with said first communication device of said interface terminal; and
interface means allowing the access to data stored on said electronic chip; and
dynamic identification data identifying said account and associated to said account, said dynamic identification data being stored on said electronic chip of said PTD and at said financial institution and which can be renewed both on said electronic chip of said PTD and at said financial institution.

23. System for the renewal of first identification data identifying and being associated to an account hosted by a financial institution, said first identification data being stored on a PTD and at said financial institution, said system comprising:
a) means for communicating to said financial institution said first identification data;
b) means for generating second identification data which is stored at said financial institution and on said PTD, in place of said first identification data; and
c) means for associating said second identification data to said account of said financial institution for the purpose of ulterior identification of said account by means of said second identification data.

24. System for the renewal of first identification data identifying and being associated to an account hosted by a financial institution, on the occasion of a transaction for the purchase of a product or service from a product or service provider by means of a PTD, said first identification data being stored on a PTD and at said financial institution hosting said account, said system comprising:
a) means for said first identification data to be communicated from said PTD to an interface terminal of said product or service provider, where transaction data is accessible;
b) means for said transaction data and said first identification data to be communicated from said terminal of said product or service provider to said financial institution;
c) means for said financial institution to locate said account by means of said first identification data and to apply said transaction data to said account;
d) means for said financial institution to generate and store second identification data;
e) means for said financial institution to associate said second identification data to said account in place of said first identification data for the purpose of ulterior identification of said account by means of said second identification data;
f) means for said financial institution to communicate said second identification data to said interface terminal of said product or service provider;
g) means for said interface terminal of said product or service provider to transfer said second identification data to said PTD; and
h) means for said PTD to store said second identification data in place of said first identification data.

25. System for the renewal of first identification data identifying and being associated to an account hosted by a financial institution, on the occasion of a transaction for the purchase of a product or service from a product or service provider by means of a PTD held by a holder of said PTD, said first identification data being stored on said PTD and at said financial institution hosting said account, said system comprising:
a) means for said first identification data to be communicated from said PTD to said holder of said PTD;
b) means for said first identification data to be communicated from said holder of said PTD to said product or service provider, where transaction data is accessible;
c) means for said transaction data and said first identification data to be communicated from said product or service provider to said financial institution;
d) means for said financial institution to locate said account by means of said first identification data and to apply said transaction data to said account;
e) means for said financial institution to generate and to store second identification data and to generate a transaction code associated to said second identification data;
f) means for said financial institution to associate said second identification data to said account in place of said first identification data for the purpose of ulterior identification of said account by means of said second identification data;
g) means for said financial institution to communicate said transaction code to said product or service provider;
h) means for said product or service provider to transfer said transaction code to said holder of said PTD;
i) means for said holder of said PTD to communicate said transaction code to said PTD; and
j) means for said PTD to generate said second identification data on the basis of said transaction code and to store said second identification data in place of said first identification data.

26. System for the renewal of first identification data identifying and being associated to an account hosted by a financial institution, on the occasion of a transaction consisting in uploading transaction data to a PTD to store it thereon, said first identification data being stored on said PTD and at said financial institution hosting said account, said system comprising:
a) means for said first identification data to be communicated from said PTD to an interface machine, a transaction request being accessible on said interface machine;
b) means for said transaction request and said first identification data to be communicated from said interface machine to said financial institution;
c) means for said financial institution to locate said account by means of said first identification data and to apply said transaction request to said account, generating transaction data;
d) means for said financial institution to generate and to store second identification data;
e) means for said financial institution to associate said second identification data to said account in place of said first identification data for the purpose of ulterior identification of said account by means of said second identification data;
f) means for said financial institution to communicate said second identification data and said transaction data to said interface machine;
g) means for said interface machine to transfer said second identification data and said transaction data to said PTD;
h) means for said PTD to store said second identification data in place of said first identification data and to store said transaction data.

27. A PTD comprising an electronic chip, interface means linked to said electronic chip, a communication device linked to said electronic chip to allow said PTD to communicate with an interface machine provided with a complementary communication device, said electronic chip comprising at least a memory member which can be read and on which data can be stored, said memory member including at least identification data identifying and associated to an account hosted in a financial institution, said identification data being renewable.

28. Method for the renewal of identification data identifying and being associated to an account hosted by a financial institution, said identification data being stored on a PTD and at said financial institution, said method including the step of the renewal of identification data which comprises the following sub-steps:
a) erasing said identification data on said PTD and at said financial institution;
b) generating new identification data;
c) storing said new identification data both on said PTD and at said financial institution; and
d) associating said new identification data to said account hosted by said financial institution for the purpose of ulterior identification of said account by means of said new identification data;
said step of renewal being accomplished every time a determined condition is respected.

29. Method according to claim 28 accomplished on the occasion of transactions, wherein said determined condition is that a transaction be accomplished.

30. Method according to claim 28 accomplished on the occasion of transactions, wherein said PTD communicates in a temporary fashion with said financial institution through the instrumentality of an interface machine when a transaction must be accomplished, and wherein said determined condition is that a communication must be established between said PTD and said financial institution through the instrumentality of said interface machine.
